(19) United States
(12) Patent Application Publication
(10) Pub. No.: US 2003/0146937 A1
(43) Pub. Date: Aug. 7, 2003

(54) Multi-level data management system

(76) Inventor: Seung Woo Lee, Newark, CA (US)

Correspondence Address: K. Jun Kim, Gray Cary Ware & Freidenrich, 1755 Embarcadero Road, Palo Alto, CA, 94303, US

(21) Appl. No.: 09/952,899

(22) Filed: Sep. 11, 2001

(51) Int. Cl. G09G 5/00

(52) U.S. Cl. 345/781

(57) ABSTRACT

The present invention provides a system and method for a consistent graphical user interface (GUI) and automatic code generation system for supporting the GUI. The invention may include. In one aspect of the embodiment, the invention provides a multi-level display window for data management, wherein the multi-level display window comprises a header frame, a column header frame, a data frame, a record number indicator, a record selection frame, and a menu frame. The record selection frame comprises selection check boxes and expansion/compression buttons. The user can select a record by clicking the select check box or clicking any text box of the record. The expansion/compression buttons are used to expand and compress the data being displayed in the data frame. The invention automatically generates application components to provide a multi-level data management system by creating a form field master based on application tables and form generation templates. The application components automatically created comprise EJB (Enterprise Java Bean), Java Bean, JSP (Java Server Page), and XML (Extensible Markup Language) documents. The users may choose to create the application components automatically or manually.

### FIELD OF THE INVENTION

This invention relates generally to a data management system. More specifically, the invention relates to a technique for providing a multi-level data management system and a user interface therefor.

### BACKGROUND OF THE INVENTION

The ever-increasing speed of the Internet access and its ubiquity present a greater number of users an opportunity to take advantage of web-based application programs and the scope of web-based applications is expanding to the enterprise-wise applications domain. The development of enterprise-wise web applications, however, requires a seamless integration of a myriad of software components in multi-tier architecture, and often leads to unsatisfactory results due to lack of relevant technologies and standards. In this regard, J2EE (Java 2 Platform Enterprise Edition) architecture has been proposed to provide a reliable application program development environment for large scale enterprise-wise applications.

When a user wants to develop a web application program in J2EE environment, different components need to be deployed in a multi-tier structure. The required components may include Enterprise Java Bean (EJB), Java Bean (JB) and Java Server Page (JSP). The actual development of the software components is a very time and effort consuming process that requires a large number of hours for manual designing and coding. Compared to other proprietary 4GL (Fourth Generation Language) development tools such as those developed by SAP and Oracle, the development productivity under J2EE architecture is relatively low.

For example, the development of HTML (HyperText Markup Language) screen design or EJBs or preparing Java Code (Java Beans) for the middle layer using J2EE development tools such as Visual Cafe would require writing a large amount of complex software codes. Further, the pattern of manually creating codes may also lack consistency and the created codes are often error-prone, making the development productivity very inefficient.

Also the need for manual coding under J2EE environment often causes user inconvenience and confusion. For example, due to lack of a well-defined user interface standard, the conventional web based software development packages fail to provide consistency for codes that are developed under different business situations. Since it is difficult to enforce a coding standard, it is also difficult for a developer to debug or maintain codes prepared by other developers. The problem is magnified when there are thousands of different business situations that must be handled differently in a particular web based application.

In view of the foregoing, it is highly desirable to provide a consistent user interface which can satisfy the requirements of various business situations for a enterprise-wise application. It is also desirable to provide a platform that allows application designers to design different user interfaces and meet various application requirements in a faster and more efficient manner. It is highly desirable to provide a platform that allows to generate application components such as EJBs, JBs, JSPs automatically and dynamically based on the underlying database structure and given application parameters.

### SUMMARY OF THE INVENTION

The present invention provides a system and method for a consistent graphical user interface (GUI) and automatic code generation system for supporting the GUI. In one aspect of the embodiment, the invention provides a multi-level display window for data management, wherein the multi-level display window comprises a header frame, a column header frame, a data frame, a record number indicator, a record selection frame, and a menu frame. The column header frame comprises a plurality of label fields. The data frame comprises a plurality of data fields matching the plurality of label fields in the column header frame so that multiple information may be displayed. The record selection frame comprises selection check boxes and expansion/compression buttons. The user can select a record by clicking a select check box or clicking any text box of the record. The expansion/compression buttons are used to expand and compress the data being displayed in the data frame. The user may select a record and expand it by activating an expansion/compression button to gain access to and display more detailed information about the entity. The multi-level display window provides multi-language versions.

In another aspect of the invention, based on application tables, the invention derives or extracts various tables comprising a table field repository and a form field master. Based on the various tables derived from the application tables and form generation templates, the invention creates a form field master. The invention may automatically generate application components to provide a multi-level data management system based on the form field master. The application components created automatically comprise EJB (Enterprise Java Bean), Java Bean, JSP (Java Server Page), and XML (Extensible Markup Language) documents. The users may choose to create the application components automatically or manually.

### BRIEF DESCRIPTION OF THE DRAWINGS

FIG. 1 is a main screen 100 formed inside a Microsoft Internet Explorer window in accordance with a preferred embodiment of the invention;

FIG. 2 illustrates a detail screen 200 constructed in accordance with one embodiment of the invention;

FIG. 3 illustrates a main search screen 300 constructed in accordance with one embodiment of the invention;

FIG. 4 illustrates a detail search screen 400 constructed in accordance with one embodiment of the invention, and

FIG. 5 is a flowchart illustrating the dynamic component generation system in accordance with one embodiment of the invention.

### DETAILED DESCRIPTION OF A PREFERRED EMBODIMENT

The invention is particularly applicable to a data management system for web-based applications and it is in this context that the invention will be described. It will be appreciated, however, that the multi-level data management system in accordance with the invention has greater utility, such as to other types of general application software development and management contexts. To understand the multi-level data management system in accordance with the invention, the basic features and underlying architecture will be described.

Window User Interface with Multi-level Data Field Representation

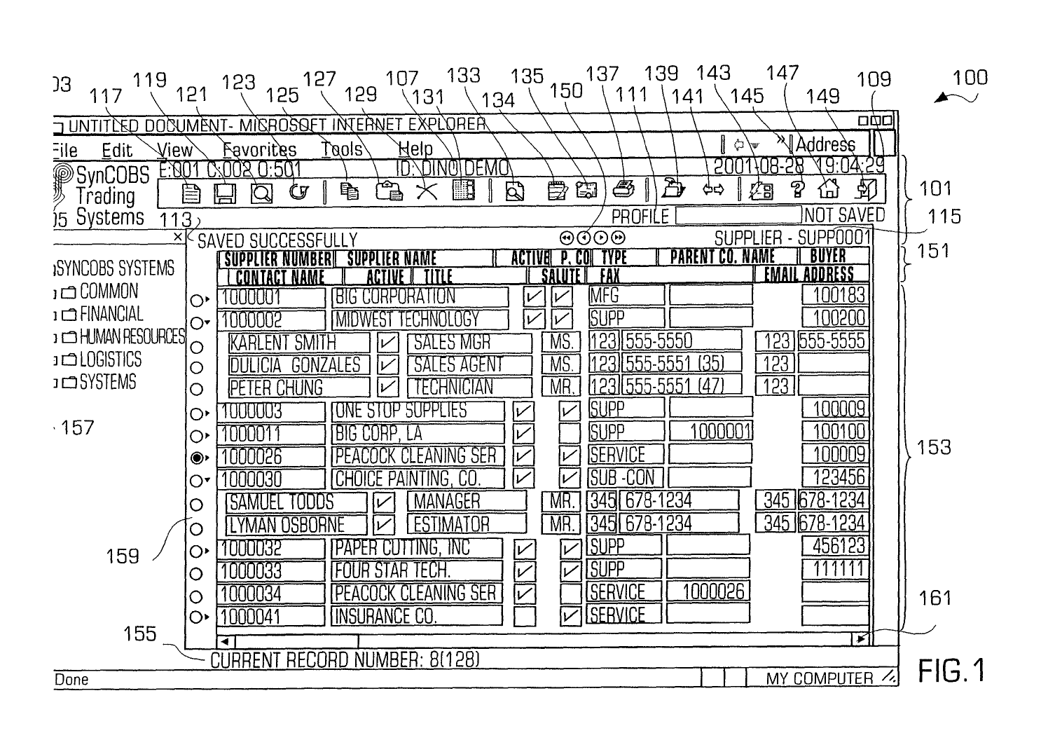

FIG. 1 is a main screen 100 formed inside a Microsoft Internet Explorer window in accordance with a preferred embodiment of the invention. It will be apparent to one skilled in the art that other browser or web access tools than the Microsoft Internet Explorer may be used in conjunction with the invention. It will be also apparent to one skilled in the art that the main screen 100 may take other shapes or forms than shown in FIG. 1. For example, the main screen 100 may have a polygon or even circular shape as required or desired by a particular application. In FIG. 1, the multi-level main screen 100 comprises Microsoft Internet Explorer application menu frame 103, header frame 101, column header frame 151, data frame 153, record number indicator 155, menu frame 157, record selection frame 159, and a scroll bar 161.

In a preferred embodiment of the invention, the header frame 101 comprises a login ID 107, logon information, activity code and description. The header frame 101 may also contain various buttons that support different application functions. For example, the header frame 101 comprises a new button 117, a save button 119, a search button 121, a logout button 149, a home button 147, a delete button 129, an exec button 143, a detail button 133, a text button 134, a special button 135, a reload button 123, a print button 137, a help button 145, a record locator button 139, a level button 141, a copy button 125, a paste button 127, scroll buttons 150, a split button. It will be apparent to one skilled in the art that the header frame 101 may comprise more or fewer information fields than shown in FIG. 1. For example, the header frame 101 may not comprise login ID in an alternate embodiment of the invention. The header frame 101 may also contain a company logo 105 in an alternate embodiment of the invention.

The column header frame 151 contains the headers for data columns 153. The number of header lines is determined by the number of levels of information. For example, in the supplier case, two levels of information (supplier header and contact) are handled by the screen. Column headers and data columns of the same level are aligned with each other. The position of the column header is determined by comparing the length of the column header and the length of the corresponding data column. The longer of the two will be used to determine the next header/column positions. The column header frame 151 may contain a vertical scroll bar (not shown, well-known in the art). Horizontal scrolling is controlled by the scroll bar in the data frame. By clicking one of the column headers, data in the data frame 153 is sorted by the column. Previous two sort keys, if available, are remembered and used as the second and the third sort keys. Note that primary keys will be distinguished by underlines.

Data frame 153 comprises data columns and data fields. The fields in the data frame 153 are arranged side by side with a maximum field size of 20 characters in a preferred embodiment. It will be appreciated by one skilled in the art that other arrangements, shapes, and size are possible. For example, the fields in the data frame 153 may be arranged parallel in rows with a larger maximum character field size. No description fields are included for code type of data (ex. description for unit of measure). If a user wants to see more detailed information, the user can switch to the detailed screen by pressing the detail button. When a user changes (or enters) any information and if the records modified (or entered anew) are about to disappear (or be hidden) by results of any screen activities such as scrolling, expansion or compression, an alert box (not shown, well-known in the art) will be displayed asking the user if he wants to save the data first. If there are too many columns, then a scroll bar appears at the bottom of the screen. When this frame scrolls horizontally, the column header frame will scroll synchronously. Validation of the fields can be done in two different ways based on the setting of a system parameter called “validation mode”. If this parameter is set to “field”, validation is performed right after the user enters the value. If this value is set to “Form”, validation is performed once at the page level.

It will be appreciated by one skilled in the art that other variations and additions are possible with the data frame 153. For example, when the mouse is placed over any code type field, a description of the code type field may be displayed in an alternate embodiment of the invention.

The record number indicator 155 is displayed at the bottom of the screen in a preferred embodiment. It will be apparent to one skilled in the art that the record number indicator 155 may be placed in other suitable location in window 100 in alternate embodiments of the invention. The record number indicator 155 displays the total number of records in the current search result set and the record number for the current record. In our example, a supplier has 3 contacts and the second record is the current record “2(3)”. If the user clicks any of the supplier header record, it will show the record number among the supplier header records and the total number of supplier header records in the current result set.

The menu frame 157 contains the application menu. For example, the menu frame 157 may display items such as common, finances, human resources, logistics, and systems folders in one embodiment of the invention, as shown in FIG. 1.

The record selection frame 159 contains selection check boxes and expansion/compression buttons. A user can select only one record at a given time. Most of the data manipulation activities such as add, delete, and modify, can be done after a record is selected. The user can select a record by clicking the select check box or clicking any text box of the record. The expansion/compression buttons are used to expand and compress the data being displayed in the data frame 153. For example, the user can select a supplier and by clicking a selection check button, the user can display or hide the contact records. Generally, a user can only expand into lower level records when the higher level record has already been added to the database. In other words, for a new supplier number, the level number may be dimmed until the save button is clicked.

Referring to the header frame 101, the logo 105 is implemented based on the graphic file name defined the customer's entries master, so that the header frame 101 automatically identifies the company's logo.

The logon information 107 may optionally display the user's logon organization level such as enterprise, company, organization and the login ID. In other embodiments of the invention, the logon information 107 may display other additional information or may display fewer items than shown in FIG. 1.

Optional data and time field 109 may display time of the day and may be updated at any suitable intervals such as at every one minute. The search profile 111 displays the current search profile name. The message line 113 is used to display messages that indicate whether the transaction has been successful or not. For example, the message line 113 may display “Saved successfully,” as shown in FIG. 1, indicating that the save transaction has been unsuccessful.

Entity type and activity code 115 is used to display the type of entity and relevant activity code. For example, in FIG. 1, SUPP0001 may represent a combination of entity name SUPP and an activity code. In a preferred embodiment of the invention, 0001 indicates viewing activity, 0002 indicates, search activity, 0003, modify activity, 0004 and 0005 indicate add and delete respectively. It will be apparent to one skilled in the art that other code and name combinations may be used for various activities in accordance with the invention. For example, shorter or longer character lengths may be used in the fields of 115.

In a preferred embodiment, the activity codes are used to control and permit access to a particular entity's database. If a user does not have access for any specific activity for an entity, information on the entity may not be displayed on the screen. If standard activities are defined for an entity, the standard activity name defined in the entity master may be displayed on the screen. For example, the activity code field 115 may display “SUPP0000—Maintain Items.” The activity code may be a combination of an entity code and “0000.” SUPP0000 may not actually exist in the activity master; and may be a hard-coded activity name reserved for representing standard activities. In a preferred embodiment, the view and search activities are available as long as the user has access permission to them, regardless of the organization level the user is logged in at. However, the range of data displayed on the screen may be varied depending on the logon organization level. It will be apparent to one skilled in the art that fewer or more activities than view and search may be made available to users having access permission.

Referring to FIG. 1, the home button 147 is used to take the user back to an organization entry screen where the user is asked to provide information regarding the user's company such as a company name and an organization name. The logout button 149 is used to log out. The save button 119 is used to save user inputs in the database. In the search activity, the save button 119 is used to save the search criteria in a search profile. The new button 117 is used to insert a new record directly below the current record. Current record indicates the record selected. Users can select one record at any given time. Users can insert a record at the same level or in the next lower level. When the new button 117 is clicked, a blank line is inserted below the current record and the records below are pushed down by one line. The new record becomes the current record. The delete button 129 is used to delete the current record.

The search button 121 is used to search records based on the user defined selection criteria. The search screen is similar to the data entry screen except for the Boolean operator selection list in front of each field. The execution button 143 is used to execute some of the batch activities such as MRP calculation, deleting dated records, for example, deleting cancelled PRs (purchase requisites), and monthly closing. The execution button 143 may also be used in a search. The detail button 133 is used to access a detail screen. The detail screen may show the same information as seen on the main screen but with the fields are arranged vertically.

The text button 134 is used to pop up the free text entry screen. The special button 135 is reserved to execute special application specific functions aside from the standard activities. When users click the special button 135, a pull down menu may expand to display an application specific menu. The pull-down menu may contain all available activities which belong to the current entity or additional controls needed for the current activity. For example, in the PR case, the pull-down menu may contains all activities for the PREQ entity such as maintain purchase requisition (PREQ0000), confirm (PREQ0008), de-confirm (PREQ0009), cancel (PREQ0010), instant approval (PREQ0011) and delete cancelled PRs (PREQ0012). When an activity is chosen from the pull-down menu, the new activity code and the description from the header frame 101 may be displayed, and if needed, the data frame 153 may display a new screen for the activity. In addition, the menu may display special controls such as current status and history in order to display additional information. In one embodiment of the invention, special actions are performed in a separate pop-up window.

When the print button 137 is clicked, the user is asked whether the user wants to get a snapshot of the current screen or print out of the entire search result set. The help button 145 is used to display the help documents.

A record locator button 139 is used to locate a record within a search result set. When the record locator button 139 is clicked, the record currently selected is blanked out and all the fields for the record become display only with the exception of the current sort key field. Then the user may enter the key field value the user wants to find and click exec button 143. For example, all the records whose field values are greater than or equal to the entered data may be displayed on the screen from the first position for the level. If the user tries to locate a record in level 1, the first record will be displayed on the top of the screen. If the user tries to locate a record in level 2 that belongs to a level 1 record, the first level 2 record will be displayed directly below the parent level 1 record. Activating the record locator button 139 does not change the content of the current result set. The level button 141 is used to toggle between the same level and a lower level. For example, if the current record is one of the supplier header records, if the user clicks the new button with the level button set to “same level”, a blank line may be displayed below the current record where the user can enter the new supplier header information. On the other hand, if the level is set to “lower level” a blank record is displayed below the current record where the user can enter the contact information.

The reload button 123 is used to reload the data from the database. The copy button 125 is used to copy an existing record to a new one. When the copy button 125 is clicked, the shape or color of selection check box may change to indicate that the record is the source record. Then the user may select any record (or not select any, then the source record itself is still the current record) where the user wants to insert a new line. When the user clicks the new button 117 and the paste button 127, the data is copied to the new record. The scroll buttons 150 are used for scrolling. In a preferred embodiment, an odometer style special scrolling algorithm may be used for fast and convenient scrolling. Users can define the maximum number of records on one screen and regardless of the data level, a page can only contain up to this predefined number. Whenever the user scrolls the data on the screen, the latest set of data is read from the database and displayed.

The invention also provides a capability to look up a list of valid values for an entity during data entry. The lookup screen may be designed to be similar to the main screen 100 in terms of appearance and the functionality. It may have a header frame, a column header frame, a data frame, selection check boxes, an expansion/compression toggle switch and “And/Or” toggle switches. It may also have a bottom frame where the record numbers are displayed. The search profile field may be in the header frame as well. In the header frame, function buttons such as save, search, exec, detail, text, cancel and record locator buttons may be displayed. The title line of a lookup screen may displays the entity name plus “Lookup.” For example, the title line may display “Commodity Code Lookup.” The bottom frame may have an OK and a cancel button. When a user selects a record from the lookup screen, the user can click the OK button to bring the value back to the main screen. In a preferred embodiment, a user selects the level 1 items.

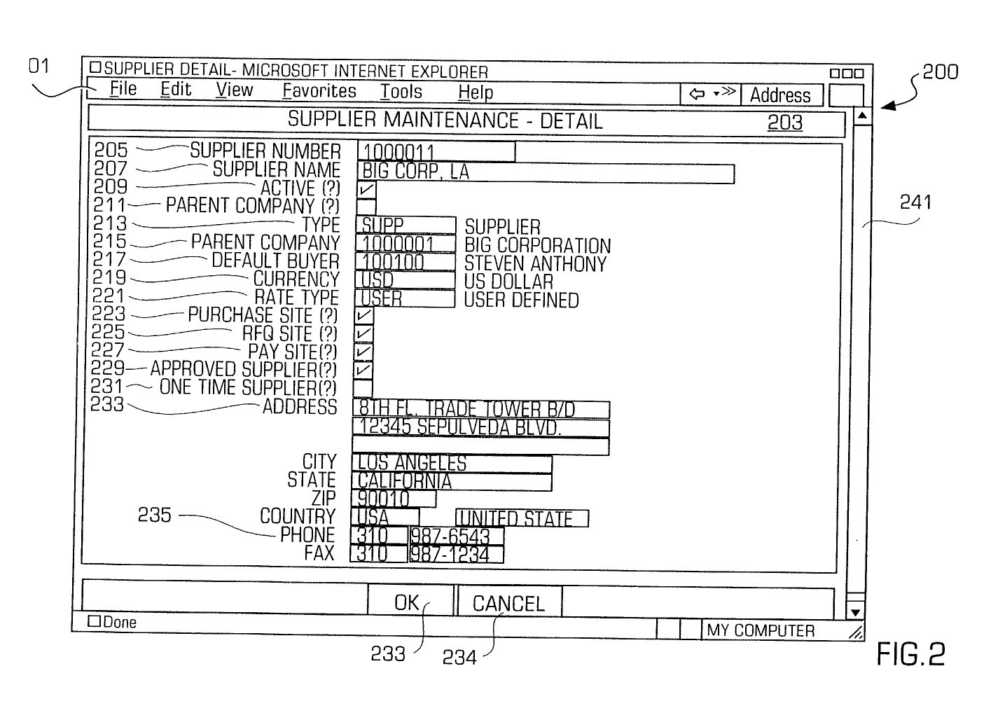

FIG. 2 illustrates a detail screen 200 constructed in accordance with one embodiment of the invention. As with the main screen 100, the detail screen 200, the detail window is provided inside a browser window, and provides a browser application menu 201. The detail screen 200 may display the same information as provided on the main screen 100 with the fields arranged vertically instead of horizontally. Descriptions for code type fields may be included in the detail screen. The order of the fields may be the same as the main screen. The field attribute (display only, input. Etc.) is determined by the type of main activity.

The detail screen 200 provides a title line 203, and data fields 205-235. Data fields in the detail screen 200 comprises the following fields: supplier number 205, supplier name 207, active 209, parent company 211, type 213, parent company name 215, default buyer 217, currency 219, rate type 221, purchase site 223, RFQ site 225, pay site 227, approved supplier 229, one time supplier 231, address 233, and phone/fax 235. It will be apparent to one skilled in the art that fewer or more data fields may be provided in the detail screen 200 than shown in FIG. 2. The detail screen 200 may contain “OK” and “cancel” buttons 237 and 239. When the OK button 237 is activated, the data entered will be displayed back to the main screen. If the cancel button 239 is clicked, the data is not entered and lost. The detail screen 200 may also comprise a scroll bar 241.

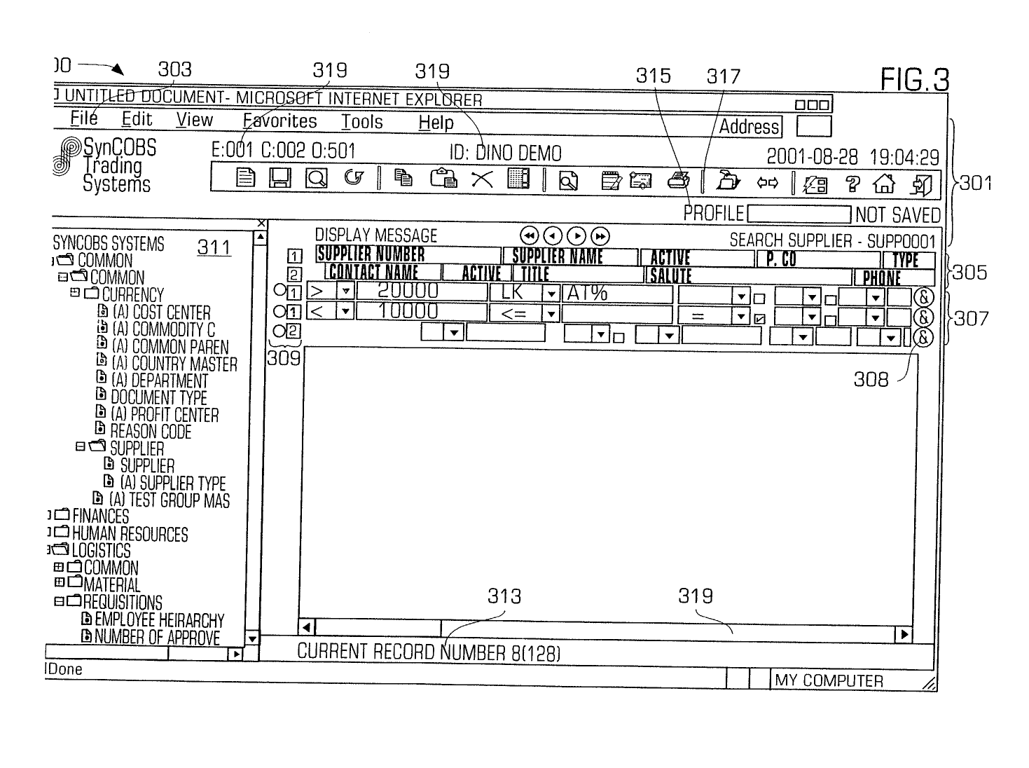

FIG. 3 illustrates a search window constructed in accordance with one embodiment of the invention. the search window displays identical items and fields as the main window 100 except for the data field 307, which displays search criteria instead of valid data items. In order to search for an entity or an item, a user enters relevant information in a search profile 315. If the user does not enter any and leaves the field blank, or if a non-existent profile name is entered (this means that the user wants to create a new profile), the blank search screen may appear. A user may also bring up a lookup window to determine a desired search profile. A search is initiated when the user activates a search button. The search criteria for the entered profile are displayed on the screen. A blank search screen may be displayed if no profile is entered. A blank search screen displays a blank line (line with blank fields) per each level. In a supplier case, two blank lines may be displayed, one for the supplier and the other for the contact. If the user needs to enter more than one line of search criteria for any level, the user may select a line for the level and add new lines by clicking the new button as many times as necessary.

An owner of the profile can modify some criteria when desired. The profile status may be displayed next to the profile field 315. For example, “Not saved” is displayed in the header frame 301 when the search criteria has not been save. The user can view or use other users' profiles but may not modify them in a preferred embodiment. It will be apparent to one skilled in the art that users may modify other users' profiles in alternate embodiments of the invention. The user may save the modified criteria by clicking the save button. A new name may be assigned to a search profile. Also, a new profile may be created by clicking the new button in the buttons frame 317 with the cursor located in the profile field. A user may delete the current profile by clicking the delete button in the buttons frame 317 with the cursor located in the profile field. In one embodiment of the invention, a confirmation alert window may be popped up with all fields blank. The user may enter data in the blank fields. When a user is in a search activity, relational symbol list boxes may appear in front of the data fields. Available relational symbols include “<”, “>”, “<=”, “>=”, “=” and “LK”. “LK” represents “like” when the SQL (structured query language) statement is generated. All list boxes may contain “all” as an option in a search activity. The user can set the AND/OR operator using the toggle buttons 308. The “AND” operator is used as a Boolean operator among fields on the same line.

The user may start a search by clicking the exec button 143 to execute the search based on the search criteria entered. The user may click the reload button 123 to reload the old profile information.

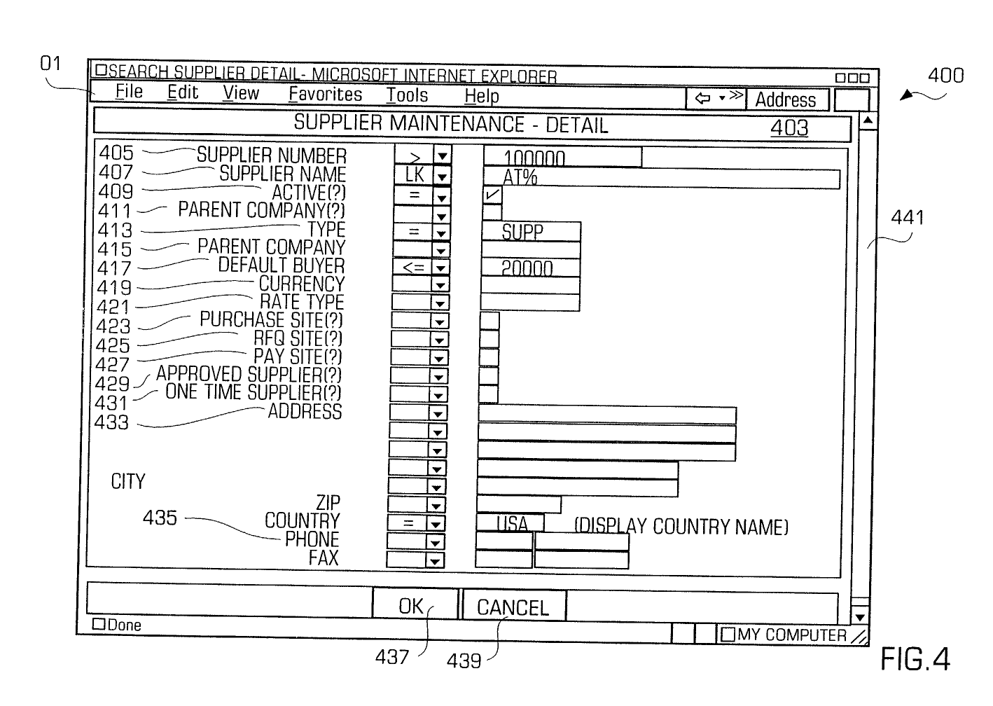

FIG. 4 illustrates a detail search screen 400 constructed in accordance with one embodiment of the invention. The fields provided in the detail search screen 400 tracks the fields of the detail screen 200 of FIG. 2. However, it will be apparent to one skilled in the art that fewer or more fields may be provided in detail search screen 400 in alternate embodiments of the invention. In comparison to the detail screen 200, the detail search screen 400 data fields display criteria instead of valid data. For example, the supplier number 405 has criteria fields instead of an actual number. The supplier name 407, active 409, parent company 411, type 413, parent company name 415, default buyer 417, currency 419, rate type 421, purchase site 423, RFQ site 425, pay site 427, approved supplier 429, one time supplier 431, address 433, and phone/fax 435 also have criteria fields. The detail search screen 400 also has menu 401, a title line 403, an OK button 437, a cancel button 439, and a scroll bar 441.

A system for dynamic component generation for multi-level data management system of the invention will now be described.

Tables

The invention provides the following tables in one embodiment of the invention: TABL01, PMKY01, FKHD01, FKFL01, DOMN01, ENUM01, TFLD01, ENTY01, ACTN01, FTMP01, FTMP02, FTMP03, FFLD01, LKUP01, LABL01, LABL02, SRCH01, and SRCH02. The tables may be any type of relational databases. It will be obvious to one skilled in the art that a fewer or more number of tables may be provided in alternate embodiments of the invention.

TABLE TABL01

| | | | Null | |
|---|---|---|---|---|
| Field Name | Data Type | Length | ? | Description |
| Table_Name | Varchar2 | 6 | N | Table Name |
| Description | Varchar2 | 60 | | |
| Audit_Trail | Number | 1 | N | enum |
| | | | | (1 = on, 2 = off), |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Table_Name

TABL01 stores application tables necessary for a preferred embodiment of the invention. It will be apparent to one skilled in the art that there may be fewer or more tables stored in TABL01 in alternate embodiments of the invention. The field Nano_Second contains the time when the associated data was accessed by a particular application program. The field Nano_Second is used for record locking in order to maintain data coherency.

TABLE PMKY01

| | | | Null | |
|---|---|---|---|---|
| Field Name | Data Type | Length | ? | Description |
| Table_Name | Varchar2 | 6 | N | Table Name |
| Field_Number | Number | 3 | N | Sequence number of |
| | | | | the field within the |
| | | | | primary key |
| Field_Name | Varchar2 | 60 | N | |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Table_Name + Field_Number
FK1: Table_Name (TABL01)

PMKY01 stores a master list of primary keys. A primary key is used to uniquely identify each record and may comprise multiple fields. PMKY01 is used to automatically generate the validation logic. PMKY01 is automatically populated by DGEN011 in a preferred embodiment of the invention. It will be appreciated by one skilled in the art that PMKY01 may be populated manually instead of automatically in alternate embodiments of the invention.

TABLE FKHD01

| | | | Null | |
|---|---|---|---|---|
| Field Name | Data Type | Length | ? | Description |
| Child_Table | Varchar2 | 6 | N | Child Table Name |
| Key_Number | Number | 2 | N | Sequence number of |
| | | | | the foreign key |
| Parent_Table | Varchar2 | 6 | N | Parent Table Name |
| Relation | Number | 1 | N | Mandatory/Null |
| | | | | allowed |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Child_Table + Key_Number
FK1: Child_Table (TABL01)
FK2: Parent_Table (TABL01)

FKHD01 contains the definitions of foreign key relations found in the application tables. FKHD01 is used to automatically generate the validation logic. A foreign key is used as a pointer from one table to another. FKHD01 is automatically populated by DGEN0101 in a preferred embodiment of the invention, but users may manually enter foreign keys that are not defined in the underlying tables.

TABLE_FKFL01

| | | | Null | |
|---|---|---|---|---|
| Field Name | Data Type | Length | ? | Description |
| Child_Table | Varchar2 | 6 | N | Table Name |
| Key_Number | Varchar2 | 60 | N | Sequence number of |
| | | | | the foreign key |
| Field_Number | Number | 2 | N | Sequence number of |
| | | | | the field within a |
| | | | | foreign key |
| Field_Name | Varchar2 | 60 | N | Field name |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Child_Table + Key_Number + Field_Number
FK1: Child_Table + Key_Number (FKHD01)
FK2: Child_Table + Field_Name (TFLD01)

FKFL01 stores foreign key fields. A foreign key may be a concatenation of multiple fields. FKFL01 is automatically populated by DGEN0101 in a preferred embodiment of the invention, but users can enter foreign keys that are not defined in the underlying tables.

TABLE DOMN01

| | | | Null | |
|---|---|---|---|---|
| Field Name | Data Type | Length | ? | Description |
| Domain | Varchar2 | 30 | N | Domain Name |
| Data_Type | Number | 2 | N | Enum (1 = byte, 2 = short, |
| | | | | 3 = integer, 4 = long, 5 = float, |
| | | | | 6 = boolean, 7 = string, |
| | | | | 8 = Timestamp, 9 = enum) Types 1 |
| | | | | thru 7 match the corresponding |
| | | | | types in Java programming |
| | | | | language |
| Length | Number | 6 | | |
| Maximum_Value | Number | | | Only for numerics |
| Minimum_Value | Number | | | Only for numerics |
| Justification | Number | 1 | N | Enum (1 = Left, 2 = Right, |
| | | | | 3 = None), only used for string |
| | | | | data type |
| Shift | Number | 1 | N | Enum (1 = Mixed, 2 = Upshift, |
| | | | | 3 = None), Only used for Roman |
| | | | | Alphabets |
| Precision | Number | 2 | | Number of digits in decimal |
| | | | | portion (left of the decimal point) |
| Creator | Varchar2 | 16 | N | |
| Date_Created | Date | | | |
| Modified_By | Varchar2 | 16 | | |
| Date_Last_Modified | Date | | | |
| Nano_Second | Number | 9 | | |

PK: Child_Table + Key_NUmber
FK1: Child_Table (TABL01)
FK2: Parent_Table (TABL01)

DOMN01 contains domain names and other relevant information such as field attributes. For example, DOMN01 contains information about field attributes of supplier or item domains.

TABLE ENUM01

| | | | Null | |
|---|---|---|---|---|
| Field Name | Data Type | Length | ? | Description |
| Domain | Varchar2 | 32 | N | Domain Name |
| Enum_Value | Number | 3 | N | Actual value |
| Enum_Label | Varchar2 | 32 | N | Label containing |
| | | | | enum text |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Domain + Enum_Value
FK1: Domain (DOMN01)
FK2: Enum_Label (LABL01)

ENUM01 contains enumeration information pertaining to each domain.

TABLE TFLD01

| | | | Null | |
|---|---|---|---|---|
| Field Name | Data Type | Length | ? | Description |
| Table_Name | Varchar2 | 6 | N | Table Name |
| Field_Name | Varchar2 | 64 | N | Field Name |
| Field_Number | Number | 3 | N | Sequence number of |
| | | | | the field |
| Domain | Varchar2 | 32 | N | Domain Name |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Table_Name + Field_Name
FK1: Table_Name (TABL01)
FK2: Domain (DOMN01)

TFLD01 contains contains the fields in the application tables. This table is used to support the enumeration feature as well.

TABLE ENTY01

| | | | Null | |
|---|---|---|---|---|
| Field Name | Data Type | Length | ? | Description |
| Entity | Varchar2 | 4 | N | Entity Code such as ITEM, UNIT |
| | | | | etc |
| Description | Varchar2 | 20 | N | Description for the entity |
| Module | Varchar2 | 3 | N | |
| Maintenance_Level | Number | 1 | N | Enum (Enterprise, Company, |
| | | | | Organization), Default = |
| | | | | Enterprise |
| Activity_Type | Number | 2 | Y | Enum (Purchase, Inventory, |
| | | | | Sales, Accounting, System, |
| | | | | Others, Unclassified), |
| | | | | default = Unclassified, If |
| | | | | maintenance level is Org, this field |
| | | | | must be defined. |
| Form_Type | Number | 1 | N | Enum (1 = Standard, 2 = Free), |
| | | | | Standard form provides standard |
| | | | | table maintenance capabilities |
| | | | | such as add, delete and modify |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Entity
FK1: Module (MODU01)

ENTY01 provides information relevant for each entity. As described in the form-type field in Table ENTY01, forms include standard forms and free forms. Standard forms are those that permit users to execute standard activities. The windows 100, 200, 300 and 400 shown in FIGS. 1, 2, 3, and 4, respectively, are examples of standard forms. The standard activities are a flexible concept and may be specified by a user in accordance with a particular application. For example, the standard activities may be defined to include add, delete, modify, search, and view. In contrast, free forms may have no pre-defined activities and users may determine particular activities associated with a free form as necessary.

TABLE ACTN01

| | | | Null | |
|---|---|---|---|---|
| Field Name | Data Type | Length | ? | Description |
| Entity | Varchar2 | 4 | N | Main Entity name |
| | | | | (level 1 entry) |
| Action_Seq | Number | 2 | N | Sequence number |
| Action_Type | Number | 1 | N | Enum (1 = Activity, |
| | | | | 2 = Action) |
| Activity | Varchar2 | 8 | | Current Activity |
| Action_Label | Varchar2 | 32 | N | Label Code for the |
| | | | | special action |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Entity + Action_Seq
FK1: Activity (ACTY01)
FK2: Action_Label (LABL01)

ACTN01 contains information for special actions for an activity. Special actions appear in the pull-down menu when the special action button is clicked. The pull-down menu contains the list of all available activities for the current entity and all the special actions that belong to the current activity.

TABLE FTMP01

| | | | Null | |
|---|---|---|---|---|
| Field Name | Data Type | Length | ? | Description |
| Entity | Varchar2 | 4 | N | Main Entity name (level 1 entry) |
| Level_Num | Number | 1 | N | Level Number |
| Table | Varchar2 | 6 | N | Main Table for the level |
| Upward_Key_Number | Number | 2 | | Foreign key number pointing |
| | | | | from a lower level to the next |
| | | | | highest level. This foreign key |
| | | | | must be defined in the foreign key |
| | | | | header (FKHD01). |
| Update_Mode | Number | 1 | N | Enum (1 = Update, 2 = Display |
| | | | | only). If this mode is set to |
| | | | | “Display Only”, this level can only |
| | | | | be viewed regardless of the |
| | | | | security settings for the relevant |
| | | | | activities. |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Entity + Level_Num
FK1: Table_Name + Upward_Key_Number (FKHD01)

FTMP01 contains form generation templates for the main tables. FTMP01 comprises information regarding relationships between different levels of data being displayed. For example, when a form such as the screen 100 supports up to five (5) levels in a preferred embodiment of the invention, the relationship between the five (5) levels of representation is provided by FTMP01. It will be apparent to one skilled in the art that more or fewer levels may be used for forms. There is one main table defined per level in a preferred embodiment of the invention.

TABLE FTMP02

| | | | Null | |
|---|---|---|---|---|
| Field Name | Data Type | Length | ? | Description |
| Entity | Varchar2 | 4 | N | Main Entity name (level 1 entiry) |
| Level_Num | Number | 1 | N | Level Number |
| Table_Name | Varchar2 | 6 | N | One of the parent tables of the |
| | | | | main table |
| Foreign_Key_{—} | Number | 2 | N | Foreign key from the main table |
| Number | | | | to the auxiliary table??. This |
| | | | | foreign key must be defined in the |
| | | | | foreign key header (FKHD01). |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Entity + Level_Num + Table_Name
FK1: Entity + Level_Num (FTMP01)

FTMP02 contains form generation templates for the auxiliary tables, which are the parents of the main table. For example, the purchase unit field in the item master is linked to the unit master and the default supplier field in the item master is linked to the supplier master. When EJBs are automatically generated, the EJBs may include the logic to read these tables. FTMP02 is mainly used for creating the validation logic or for grabbing the description for a code from the table master.

TABLE FTMP03

| | | | Null | |
|---|---|---|---|---|
| Field Name | Data Type | Length | ? | Description |
| Entity | Varchar2 | 4 | N | Main Entity name (level 1 entity) |
| Level_Num | Number | 1 | N | Level Number |
| Table_Name | Varchar2 | 6 | N | One of child tables of the main |
| | | | | table |
| Foreign_Key_{—} | Number | 2 | N | Foreign key from the auxiliary |
| Number | | | | table to the main table. This |
| | | | | foreign key must be defined in the |
| | | | | foreign key header (FKHD01). |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Entity + Level_Num + Table_Name
FK1: Entity + Leve_Numl (FTMP01)

FTMP03 contains form generation templates for the auxiliary tables, which are the children of the main table. When EJBs are automatically generated, the EJBs may include the logic to read these tables. For an entry in the main table, there can be only one entry (or none) in the auxiliary table in a preferred embodiment. If there are more than one entries, only the first entry will be read and available in EJBs, JBs and JSPs.

TABLE FFLD01

| | | | Null | |
|---|---|---|---|---|
| Field Name | Data Type | Length | ? | Description |
| Entity | Varchar2 | 4 | N | Entity Code |
| Field_Type | Number | 1 | N | Enum (1 = Table, 2 = Form) |
| Table_Name | Varchar2 | 6 | | Null (and display only) if field |
| | | | | type is not a table |
| Field_Name | Varchar2 | 64 | N | Field Name |
| Field_Number | Number | 3 | N | Fields appear on the form in the |
| | | | | order of the sequence number |
| Domain | Varchar2 | 32 | N | Null (and display only) if field |
| | | | | type is table. It determines the |
| | | | | client side (Java script) validation. |
| Field_Label | Varchar2 | 32 | | Mandatory for standard forms. If |
| | | | | this field is left null (for free |
| | | | | forms), the field will be created |
| | | | | on the form without a label. |
| | | | | Engineers must add the label by |
| | | | | hand. However, they cannot use |
| | | | | any hard-coded label text. They |
| | | | | must use “getLabel” instead. See |
| | | | | detail design for details about |
| | | | | “getLabel”. |
| Attribute | Number | 1 | N | Enum (1 = Input, 2 = Display) |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Entity + Field_Type + Table_Name + Field_Name
FK1: Table_Name (TABL01, Null)
FK2: Domian (DOMN01)
FK3: Field_Label (LABL01, Null)
Index1, unique: Entity + Field_Number

FFLD01 contains definitions of fields of a form. All fields of a form are defined in FFLD01 before the form can be dynamically generated. Fields can be copied from the TFLD01 (table field repository) or manually entered.

TABLE LKUP01

| | | | Null | |
|---|---|---|---|---|
| Field Name | Data Type | Length | ? | Description |
| Entity | Varchar2 | 4 | N | Entity Code |
| Field_Type | Number | 1 | N | Enum (1 = Table, 2 = Form) |
| Table_Name | Varchar2 | 6 | | Null (and display only) if field |
| | | | | type is not table |
| Field_Name | Varchar2 | 64 | N | Field Name |
| Lookup_Seq | Number | 2 | N | Lookup sequence number |
| Lookup_Label | Varchar2 | 32 | N | When a field is linked to multiple |
| | | | | lookups, a selection popup |
| | | | | appears allowing users to choose |
| | | | | the appropriate lookup (ex. |
| | | | | Online Approvers, Offline |
| | | | | Approvers). The title of the |
| | | | | lookup is defined in the label. |
| Lookup_Entity | Varchar2 | 4 | N | This determines which lookup |
| | | | | screen will be displayed. |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Entity + Field_Type + Table_Name + Field_Name + Lookup_Seq
FK1: Entity + Field_Type + Table_Name + Field_Name (FFLD01)
FK2: Lookup_Label (LABL01)
FK3: Lookup_Entity (ENTY01)

LKUP01 is used to indicate which lookup(s) pops up when the lookup button is clicked.

TABLE_LABL01

| | | | Null | |
|---|---|---|---|---|
| Field Name | Data Type | Length | ? | Description |
| Label_Code | Varchar2 | 32 | N | Label Code |
| Length | Number | 9 | N | Length in number of |
| | | | | pixels |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Label_Code

LABL01 contains definitions of the actual text for each label is defined in table LABL02.

TABLE LABL02

| | | | Null | |
|---|---|---|---|---|
| Field Name | Data Type | Length | ? | Description |
| Label_Code | Varchar2 | 32 | N | |
| Language_Code | Varchar2 | 2 | N | 2 character language code |
| Label_Text | Varchar2 | 128 | N | Text for label code for specific |
| | | | | language |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Label_Code + Language_Code
FK1: Label_Code (LABL01)

LABL02 contains the text for label codes for different languages.

TABLE SRCH01

| | | | Null | |
|---|---|---|---|---|
| Field Name | Data Type | Length | ? | Description |
| Profile_Name | Varchar2 | 32 | N | Coded Name of the |
| | | | | Profile |
| Profile_Desc | Varchar2 | 128 | N | Profile description |
| Owner | Varchar2 | 16 | N | Owner's login ID |
| Entity | Varchar2 | 4 | N | Indicates for which |
| | | | | entity the |
| | | | | profile is used. |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Profile_Name
FK1: Profile_Label (LABL01)

SRCH01 stores a set of search criteria under a profile saved by a user.

TABLE SRCH02

| | | | Null | |
|---|---|---|---|---|
| Field Name | Data Type | Length | ? | Description |
| Profile_Name | Varchar2 | 32 | N | Coded Name of the Profile |
| Line_Number | Number | 4 | N | The line number where the |
| | | | | selection criteria is entered. |
| | | | | Blank line numbers will not be |
| | | | | counted when this record is |
| | | | | created. |
| Sequence | Number | 4 | N | The sequence number where the |
| | | | | field (where data is entered) |
| | | | | appears. |
| Level_Num | Number | 1 | N | Level Number |
| Table_Name | Varchar2 | 6 | N | |
| Field_Name | Varchar2 | 32 | N | The field name must be defined in |
| | | | | the form field master. |
| Relation_Symbol | Number | 1 | N | Enum (1 = “=”, 2 = “<”, 3 = “>”, |
| | | | | 4 = “<=”, 5 = “>=”, 6 = “LK”) |
| Numeric_Value | Number | | | If the field domain is numeric or |
| | | | | enum type, this field will contain a |
| | | | | value. For any record, either the |
| | | | | numeric value field or the |
| | | | | character value field will contain a |
| | | | | value. |
| Character_Value | Varchar2 | 256 | | If the field domain is a string type, |
| | | | | this field will contain a value. For |
| | | | | any record, either the numeric |
| | | | | value field or the character value |
| | | | | field will contain a value. |
| Boolean_Operator | Number | 1 | N | Enum (1 = and, 2 = or). The |
| | | | | operator of the last field of a line |
| | | | | denotes the relation between the |
| | | | | whole current line and the whole |
| | | | | next line. (line 1 selection criteria |
| | | | | ...) and/or (line 2 selection |
| | | | | criteria) |
| Creator | Varchar2 | 16 | | |
| Date_Created | Date | | | |
| Modified_By | Varchar2 | 16 | | |
| Date_Last_Modified | Date | | | |
| Nano_Second | Number | 9 | | |

PK: Profile_Name + Line_Number + Sequence

SRCH02 stores detailed information of a search profile.

Dynamic Component Generation (DCG) System

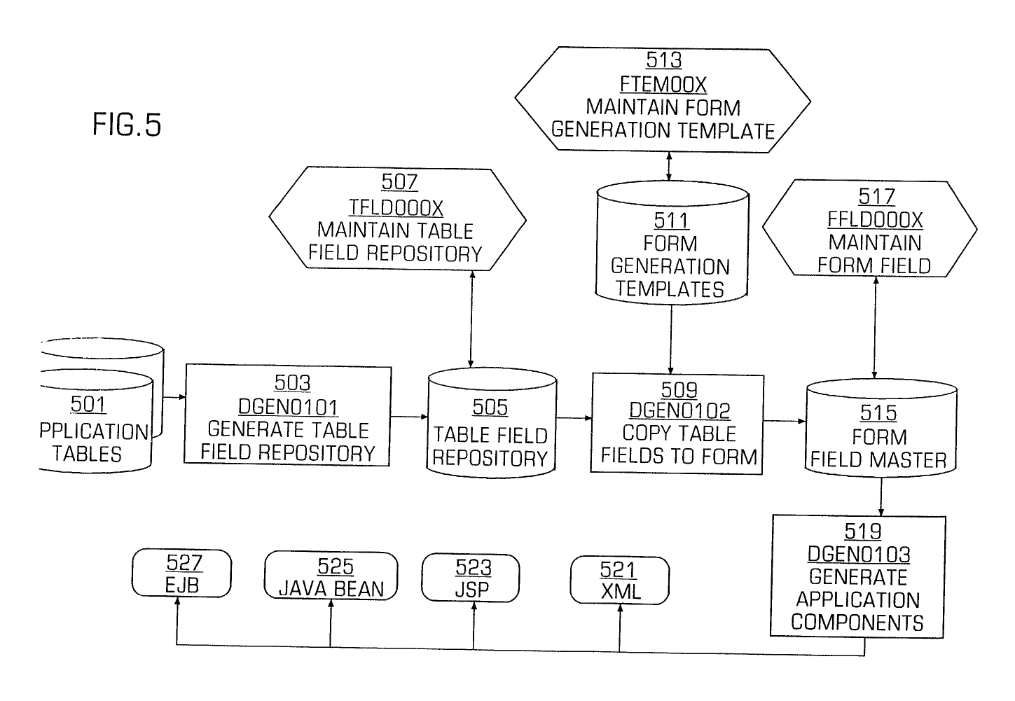

FIG. 5 is a flowchart illustrating the dynamic component generation system in accordance with one embodiment of the invention. It will be apparent to one skilled in the art that other variations can be used in alternate embodiments of the invention. Based on application tables 501, the invention derives or extracts various tables such as TABL01, PMKY01, FKID01, FKFL01, DOMN01, ENUM01, TFLD01, ENTY01, ACTN01, FTMP01, FTMP02, FTMP03, FFLD01, LKUP01, LABL01, LABL02, SRCH01, and SRCH02 described above. The application tables comprise various tables that may be necessary in a particular application context. For example, the application tables may comprise suppliers tables, items tables, and controller tables. Based on the various tables derived from the application tables, the invention may automatically generate application components to provide a multi-level data management system.

Specifically, in FIG. 5, in step 503, DGEN0101 process reads the metadata of application tables 501 and populates the table field repository 505. An example of the table field repository 505 is illustrated in TFLD01, described above. The metadata comprises structural information of a table such as field names, field types and lengths. Users can generate the table field repository 505 for a specific table or a range of tables. Default standard domains are mapped to each table field. Standard domains are pre-defined in the table DOMN01. DGEN0101 process also generates the primary key master table PMKY01, foreign key header table FKHD01 and foreign key field master table FKFL01. Table 1 illustrates the list of standard domains used in the system and mappings to the corresponding Oracle database field types as an example. It will be apparent to one skilled in the art that other data types may be used in conjunction with the invention.

TABLE 1

| Domains | Data Type | Oracle Data Type |
|---|---|---|
| stdstr??? (??? = length of the | string | Char, Varchar2 |
| string) | | |
| stdint | integer | Number(1) thru |
| | | Number(9) |
| stdlong | long | Beyond Number(9) |
| stdfloat | float | Number |

Once mapping rules are determined, they may be hard-coded in table DGEN0101.

In step 507, the user may use a process TFLD000X in order to maintain the table field repository 505. In a preferred embodiment of the invention, the TFLD000X process provides a GUI for convenient interface. Since DGEN0101 503 maps the data types to the standard domains, users may need to change the standard domains to the ones they actually desire to use. For example, there is nothing in the Oracle database indicating whether a field value is enumerated. Since the Oracle database does not have facility to indicate enumeration and merely provides a one (1) or two (2) digit integer, users may replace the standard domain (for example, stdint) to an enum type domain.

In step 509, a process DGEN0102 copies fields from the table field repository 505 to the form field master 515 based on form generation templates 511. An example of the form field master 515 is illustrated in FFLD01, described above. The step 509 may be defined as a special activity of a FTEM000X process of step 513 in alternate embodiments of the invention. Examples of the form generation templates 511 include FTMP01, FTMP02, and FTMP03. The form generation templates 511 are used to provide information that describes the relationship among application tables for various multi-level data management screens such as the screen 100 of FIG. 1 and the screen 200 of FIG. 2. In step 513, a user may define the underlying tables for a form, their relationships in the multi-level and the common key fields between the tables using the process FTEM000X.

A form field master 515 is then created based on the table field repository 515 and one or more form generation templates 511. In step 517, a user may manually enter or modify the form field master 515 using a process FFLD000X. The users may also add new fields to a form, delete fields or change fields using the process FFLD000X. In step 519, a DGEN0103 process is used to create various application components based on the form definition provided by the form field master 515. The process DGEN0103 may be defined as a special activity of the process FFLD000X in alternate embodiments of the invention. Using the process DGEN0103, the user may choose to automatically generate various application components such as EJB 527, Java Bean 525, JSP 523, and XML (Extensible Markup Language) documents 521 according to the user's needs. For example, the user may choose to generate EJB, Java Bean, and JSP automatically, but generate XML manually. The user may use EJB 527, Java Bean 525, JSP 523, and XML documents 521 for standard forms, and may use JSP 523 for free forms.

The EJB 527 is mainly responsible for data management and transaction management such as add or delete. For EJB 527, the user may select the activity (or activities) they want to create from the following choices: add, view, delete, search and modify in a preferred embodiment of the invention. It will be apparent to one skilled in the art that fewer or more activities may be used in conjunction with EJB in alternate embodiments of the invention. Based on a user selection, corresponding session EJBs and entity EJBs can be created by the process DGEN0103, and entities and activities may be defined for each level. The following is exemplary code elements created in EJBs:

/* exemplary pseudocode for entity EJB */
Home Interface: defines the methods that allow a client to create, find
or remove an EJB.

FindByPrimaryKey - returns an EJB object for the specified
Primary Key.
Create - returns the EJB object for a newly created entity.

Remote Interface: defines the business methods that a client may call.

GetRawData - returns data to a client, which is retrieved from DB.
UpdateRawData - updates data as per client requests.

Primary Key: defines a unique EJB object identifier.
Enterprise Bean: defines all APIs declared on both Home and Remote
interfaces.
Data Object : defines the data object which is transferred to and
from an EJB client.
/* exemplary pseudocode for session EJB */
Home Interface: defines the method that allows a client to locate an EJB.

Create - returns a Session EJB entity.

Remote Interface: defines the business methods that a client may call.

addData
deleteData
updateData
getData
getPKData
listData
getEnumeration

Enterprise Bean: defines all APIs declared on both Home and Remote
interfaces.

Java Bean 525 defines accessor methods such as ‘get’ and ‘set’, and interfaces to EJBs such as ‘doAction’. The accessor methods are dependent on the data and the screen definition. The interface to EJBs is used to enable JSP actions to get proper data through EJB. In a preferred embodiment of the invention, the accessor methods may comprise getsupplier_Num getSupplier_Name, setSupplier_Num, and setSupplier_Name. The interfaces to EJBs may comprise methods: doAction, addData, updateData, deleteData and groupData. It will be apparent to one skilled in the art fewer or more methods may be defined and used for accessors and EJB interfaces.

JSP is used to provide GUI screens such as shown in FIGS. 1-4. For JSP 523, a main, detail, search, lookup or the free form may be created based on the options selected by the process DGEN0103. For example, using label and field information based on DOMN01 and FFLD01, DGEN0103 may create the main window 100. Generally, field label or texts are not hard-coded on the resulting JSPs. A new common Java method (for example, “getLabel”) may be created to dynamically grab the appropriate labels based on the language used. The method getLabel may use the language code and the label code as input parameters. The column headers and the fields may be aligned and the client side data validation logic may be automatically created in a preferred embodiment of the invention.

More specifically, JSP 523 comprises interfaces to Java Bean and generates the HTML and Java Script. JSP directive may be used to define the attributes of a page and the global values. JSP tags may be used to declare the runtime actions which interface with Java Bean. For example, JSP directive may comprise page import and include file, and Java Bean interface may comprise jsp:useBean id, jsp:setProperty name, and script language. For multi-language support, JSP 523 may comprise versions written in different languages in order to provide windows 100, 200, 300 and 400 written in the different languages.

The code necessary for rendering and receiving XML documents 521 is created by the process DGEN0103 for supporting various transactions and front-end-independent business components.

Thus, the advantages of the present invention comprise:

High productivity: It enhances the software development productivity dramatically, thereby shortening the development cycle to less than half of the conventional software suites.

Consistency: By generating the application components using a series of predefined procedures, consistency is maintained throughout the entire application in the user interface (look-and-feel, navigation, etc.) and in the program logic.

Easy maintenance: Since most of the program logic is automatically written by predefined procedures, it is easy to maintain for bug fixes or enhancements later.

Multi language support: Since all the screen components are dynamically generated, the multi-level data management screens support multi-languages.

Flexible search: Users can easily define or modify their own search criteria and reuse them as needed.

Performance control: Users can set the two performance control parameters-number of records displayed on one screen and data validation mode. Users can balance between the performance and the user convenience by controlling these two parameters properly. For example, intranet users may want to set these parameters differently from Internet users.

Flexible data view: Screen standard provides two different views for the data-horizontal (multi-record) view and vertical view. Users can choose either to fit their application needs.

The foregoing description, for the purposes of explanation, used specific nomenclature to provide a thorough understanding of the invention. For example, illustrations have been given with respect to Java and Java Beans. However, it will be apparent to one skilled in the art that the specific details are not required in order to practice the invention and the invention is In other instances, well known software routines and programs are shown in block diagram form in order to avoid unnecessary distraction from the underlying invention. The foregoing descriptions of preferred embodiments of the present invention are presented for purposes of illustration and description. They are not intended to be exhaustive or to limit the invention to the precise forms disclosed. It will be appreciated by those skilled in the art that changes in this embodiment may be made without departing from the principles and spirit of the invention, the scope of which is defined by the appended claims.

1. A computer program product for a multi-level display window for data management, wherein said multi-level display window comprises a column header frame and a data frame, the computer program product comprising a computer readable storage medium and a computer program mechanism embedded therein, the computer program mechanism comprising:
instructions for generating a first label field in said column header frame;
instructions for generating a second label field in said column header frame, wherein said second label field is related to said first label field;
instructions for generating a first data field in said data frame, wherein said first data field corresponds to said first label field;
instructions for generating an expansion/compression button in said multi-level display window; and
instructions for generating a second data field in said data frame upon activation of said expansion/compression button, wherein said second data field corresponds to said second label field,
whereby said second data field is displayed as an expansion of said first data field upon said activation of said expansion/compression button.

2. The computer program product of claim 1 further comprising:
instructions for generating a header frame in said multi-level display window.

3. The computer program product of claim 2 further comprising:
instructions for generating an entity code in said header frame; and
instructions for generating a plurality of application function buttons in said header frame.

4. The computer program product of claim 1 further comprising instructions for generating a scroll bar.

5. The computer program product of claim 4 further comprising instructions for generating an application menu in said multi-level display window.

6. The computer program product of claim 5 further comprising instructions for generating a record number indicator in said multi-level display window.

7. The computer program product of claim 6 further comprising instructions for generating a message line in said multilevel display window.

8. The computer program product of claim 1 further comprising:
instructions for generating a third label field in said column header frame;
instructions for generating a fourth label field in said column header frame;
instructions for generating a third data field in said data frame, wherein said third data field corresponds to said third label field;
instructions for generating a fourth data field in said data frame upon said activation of said expansion/compression button, wherein said fourth data field corresponds to said fourth label field,
whereby said first and third data fields expand and display said second and fourth data fields related to said first data field and said third data field upon said activation of said expansion/compression button.

9. The computer program product of claim 8 wherein said first label comprises an entity number, said second label comprises a contact name, said third label comprises an entity name, and said fourth label comprises an active title.

10. A computer program product for dynamic application component generation based on a plurality of application tables, the computer program product comprising a computer readable storage medium and a computer program mechanism embedded therein, the computer program mechanism comprising:
instructions for generating a table field repository based on said plurality of application tables,
instructions for generating a form generation template;
instructions for generating a form field master based on said table field repository and form generation template; and
instructions for generating application components based on said form field master.

11. The computer program product of claim 10 further comprising:
instructions for copying fields from said table field repository to said form field master.

12. The computer program product of claim 11 wherein said form generation template comprises information that describes relationships among said plurality of application tables.

13. The computer program product of claim 12 wherein said application components comprise a JSP (Java Server Page).

14. The computer program product of claim 12 wherein said application components comprise a EJB (Enterprise Java Bean), a Java Bean, a JSP (Java Server Page), and an XML (Extensible Markup Language) document.

15. A computer program product for dynamic application component generation based on a plurality of application tables for creating a multi-level display window for data management, wherein said multi-level display window comprises a column header frame and a data frame, the computer program product comprising a computer readable storage medium and a computer program mechanism embedded therein, the computer program mechanism comprising:
instructions for generating a table field repository based on said plurality of application tables,
instructions for generating a form generation template;
instructions for generating a form field master based on said table field repository and form generation template;
instructions for generating application components based on said form field master,
wherein said application components comprising:
instructions for generating a first label field in said column header frame;
instructions for generating a second label field in said column header frame, wherein said second label field is related to said first label field;
instructions for generating a first data field in said data frame, wherein said first data field corresponds to said first label field;
instructions for generating an expansion/compression button in said multi-level display window; and
instructions for generating a second data field in said data frame upon activation of said expansion/compression button, wherein said second data field corresponds to said second label field,
whereby said second data field is displayed as an expansion of said first data field upon said activation of said expansion/compression button.

16. The computer program product of claim 15 further comprising:
instructions for copying fields from said table field repository to said form field master.

17. The computer program product of claim 16 wherein said form generation template comprises information that describes relationships among said plurality of application tables.

18. The computer program product of claim 17 wherein said application components further comprises instructions for generating a header frame in said multi-level display window.

19. The computer program product of claim 17 wherein said application components further comprises:
instructions for generating an entity code in said header frame; and
instructions for generating a plurality of application function buttons in said header frame.

20. The computer program product of claim 19 wherein said application components further comprises instructions for generating a scroll bar.
